(19) United States
(12) Patent Application Publication
(10) Pub. No.: US 2025/0217184 A1
(43) Pub. Date: Jul. 3, 2025

(54) ACCELERATED MACHINE LEARNING MODEL EXECUTION

(71) Applicant: American Express Travel Related Services Company, Inc., New York, NY (US)

(72) Inventors: Amol Salunkhe, Short Hills, NJ (US); Brian C. Rosenfield, Mukilteo, WA (US); Krishna Sunkara, Scottsdale, AZ (US); Man Chon U, Weston, FL (US); Reza Zahrani, Phoenix, AZ (US)

(21) Appl. No.: 18/397,676

(22) Filed: Dec. 27, 2023

(51) Int. Cl. G06F 9/48

(52) U.S. Cl. CPC G06F 9/4881

(57) ABSTRACT

Disclosed are various embodiments for accelerating the execution of machine learning model-based application on various computing hardware infrastructure. In non-limiting example, a system comprises a computing device that is configured to initiate a run-time execution of an application that includes a machine learning model. The computing device is further configured to determine a plurality of eligible application templates and select an application template among the plurality of eligible applications templates. The application can be executed in a run-time environment specified by the application template.

### BACKGROUND

In many industries, companies are developing software applications that include machine learning models. The machine learning models can be used to generate predictions after identifying patterns in relevant training datasets. The training datasets are a valuable component for generating an accurate machine learning model. Often times, software developers use a modeling framework and an execution framework to integrate the trained machine learning model into a software application.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting an execution environment according to various embodiments of the present disclosure.

FIG. 2 is a drawing of a network environment according to various embodiments of the present disclosure.

FIG. 3 is a flowchart illustrating one example of functionality implemented as portions of a service executed in a computing environment in the network environment of FIG. 2 according to various embodiments of the present disclosure.

FIG. 4 is a flowchart illustrating one example of functionality implemented as portions of a service executed in a computing environment in the network environment of FIG. 2 according to various embodiments of the present disclosure.

### DETAILED DESCRIPTION

The various embodiments of the present disclosure relate to accelerating the scheduling and the execution of machine learning models on heterogeneous computing hardware infrastructure. Machine learning models can be difficult and time consuming to schedule and execute in a run time environment because of various computing infrastructure, various software frameworks, and middle ware ecosystems. For example, a first type of machine learning model may need a first arrangement of software frameworks and middleware software in order to execute efficiently on the computing infrastructure. A second type of machine learning model may use a second arrangement of software frameworks and middleware software. Each arrangement can require the maintenance of a separate software stack for using the machine learning based application. In addition, because of the complex software layers involved, software developers need to be highly skilled in various software technologies. As a result, the complex workflow of various technologies can cause errors because software developers have to be highly skilled in various software technologies. In addition, because of the various technologies involved, there is not a consist governance process for each technology pipeline in many organizations.

Various embodiments of the present disclosure relate to an improved process for scheduling and executing machine learning model-based application on different computing hardware infrastructure. The improved process can improve the execution time of the machine learning model-based application on various computing hardware infrastructure. Each computing hardware infrastructure can represent a different types of computing processors, different quantities of computing processors, different hardware accelerators, and other suitable attributes. In some examples, the embodiments can be configured to a compile a machine learning model-based application once and the machine learning model-based application can be executed on various computing hardware infrastructure. Additionally, the embodiments can provide a single interface for scheduling the execution of the machine learning model-based application on different computing hardware infrastructure and provide a transparent execution process. For example, the embodiments can include a centralized priority-based scheduling system and a standardized process for executing machine learning model-based application even with varying computing hardware infrastructure.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

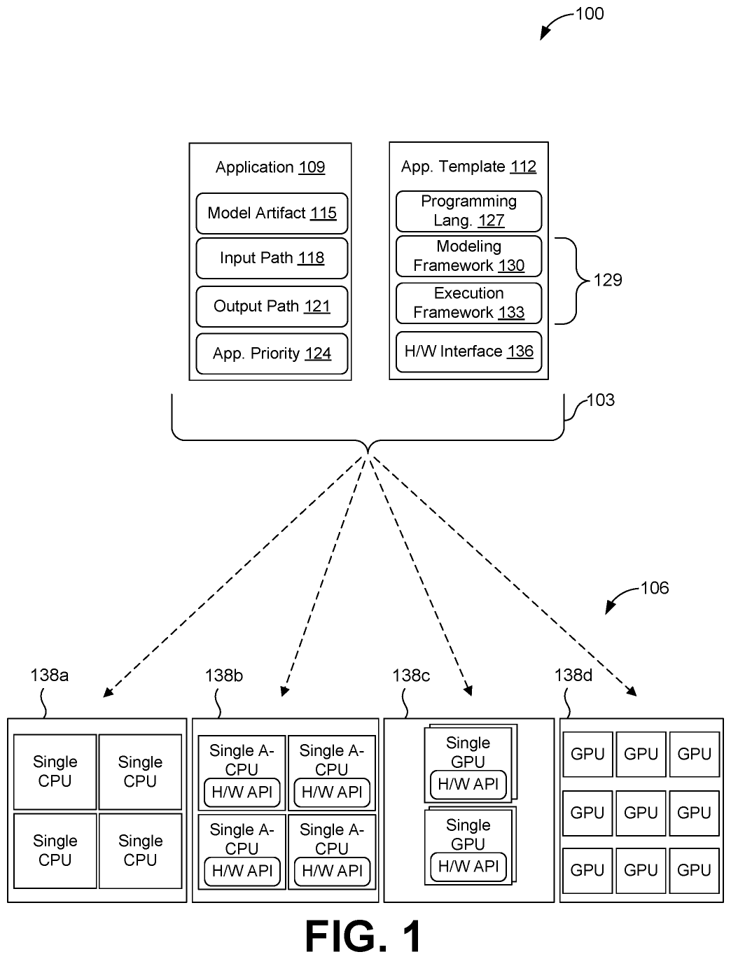

As illustrated in FIG. 1, shown is a drawing of an execution environment 100 that includes various computing hardware infrastructure according to various embodiments of the present disclosure. The execution environment 100 can represent a run-time environment for executing a machine learning-based application. The execution environment 100 can include an application package 103, a computing hardware infrastructure 106, and other suitable components. The application package 103 can represent data packaged with an application 109 in order to facilitate the scheduling and execution of the application 109 in a particular computing hardware infrastructure 106. The application package 103 can include the application 109 and an application template 112. Components of the application package 103 can specify a configuration of the execution environment 100.

The application 109 can represent an executable software application that includes a trained machine learning model. The application 109 can include a machine learning model artifact 115 (hereinafter referred to as “a model artifact 115”), an input path 118 for retrieving input parameters, an output path 121 for storing predictions and other output data from the machine learning model, an application priority 124, and other suitable components.

The model artifact 115 can represent data that results from training a machine learning model, in which the model artifact can include trained parameters, a machine learning model definition that describes how to compute inferences, weights, coefficients, biases, and other metadata. In some instances, the model artifact 115 can be packaged as a pickle file or other suitable file formats. A machine learning model can represent can be a file that has been trained to recognize certain types of patterns. In some examples, the machine learning model is the output (e.g., an output file) from a machine learning algorithm that has processed or analyzed training data. Each machine learning model can represent learned data and a series of instructions for executing a task, such as a prediction, a classification, and other suitable machine learning tasks.

The input path 118 can represent a memory location for storing input parameters and other machine learning model data for executing a machine learning model. The input path can be directed to a location of an internal computing environment or other external computing environments. In some embodiments, the input path 118 can include data attributes related to the availability of the input data. For example, when input data is stored an in external computing environment, the input data may be available under certain conditions (e.g., timing conditions, scenario conditions, etc.). The data attributes describing the availability of the input data can be conditions considered during a scheduling of the application 109. In some examples, the input path 118 can include a directory path, an Internet Protocol address, or other suitable path indicators.

The output path 121 can represent a memory location for storing model predictions, application output data, and other suitable output data. In some examples, the output path 121 can include a directory path, an Internet Protocol address, or other suitable path indicators. In some instances, the output path 121 can represent a storage location for an external computing environment.

The application priority 124 can represent a priority indicator for the application 109. The application priority 124 can be used to direct how to schedule the application 109. In some examples, the application priority 124 can be expressed as one of multiple tiers (e.g., low priority, normal priority, high priority), as a value in a range from a bottom value to a top value (e.g., on a scale between 1 and 10), or expressed using other priority systems or indicators. In some instances, the application priority 124 can be specified manually by a developer or determined automatically by the management service 212 based at least on in part on use case scenario conditions associated with the application 109.

The application template 112 can represent a set of software layer components that can be selected and used to execute the application 109 on a particular computing hardware infrastructure 106. A particular application template 112 can be selected among various application templates 112 based at least in part on their applicability to execute a particular machine learning model and the availability of a particular computing hardware infrastructure 106. The application template 112 can represent a programming language 127, a software framework 129 (e.g., a modeling framework 130, an execution framework 133), a computing hardware interface 136, and other suitable components. In some examples, the application template 112 is compatible for execution on a limited quantity of the hardware platforms 138 because the components of the application 109 can be optimized for one or more of the modeling framework 130, the execution framework 133, the computing hardware interface 136, and other suitable components.

The programming language 127 can represent one or more programming languages (e.g., PYTHON®, JAVA®, Scala, R, etc.) used by an application developer, a model developer, or other suitable developers. The programming language 127 can be used to develop the application 109, the machine learning model, and/or other suitable components of the application 109 or a software framework. As such, in some embodiments, the programming language 127 can represent one software layer of a software stack for the application template 112.

The software framework 129 can represent the modeling framework 130, the execution framework 133, and other suitable frameworks. The modeling framework 130 can represent a model framework that has application programming interfaces (APIs) used by model developers. Some non-limiting examples can include Sklearn (scikit-learn), Xgboost, MLlib, RAPIDS, and other suitable modeling frameworks. In some embodiments, the modeling framework 130 can represent a software layer in a software stack for the application template 112.

The execution framework 133 can represent a distributed execution framework used for distributed execution across a computing processing cluster. Some non-limiting examples can includes Dask, pySpark, Spark, Sklearn, —joblibl, and other suitable execution frameworks. In some embodiments, the execution framework 133 can represent a software layer in a software stack for the application template 112.

The computing hardware interface 136 can represent a hardware accelerator that operates as a low-level hardware interface for modeling and execution frameworks. The computing hardware interface 136 can represent a specific interface design to optimize execution of certain machine learning models. Some non-limiting examples can include oneDAL, CUDAR, and other suitable hardware interfaces. In some embodiments, the computing hardware interface 136 can represent a software layer in a software stack for the application template 112.

The computing hardware infrastructure 106 can represent a collection of different computing hardware platforms 138a-d (collectively “hardware platforms 138”) for executing a machine learning-based application. In some examples, the hardware platforms 138 can include a variety of different computing hardware configuration, such as a different processor configuration, a different memory configuration, hardware accelerator configuration, or other suitable computing hardware components. For example, a first hardware platform 138a can include four single core central processing units and a second hardware platform 138b can include four single core A-central processing units with a manufacturer (e.g., INTEL®, AMD®, etc.) accelerator interface. The single core A-central processing units can represent a hardware accelerator component. Certain types of machine learning models may not be compatible with certain computer processing platforms, or they may execute in a slower or less efficient manner.

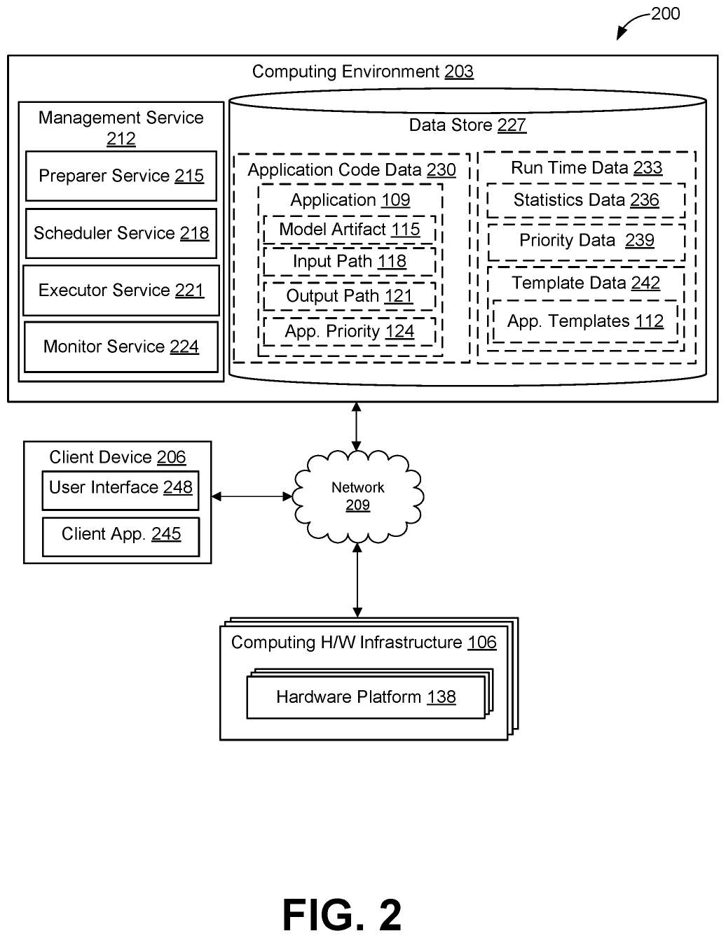

In some examples, a management service 212 (FIG. 2) can receive a request to initiate a scheduling of an execution of an application 109. Prior to execution, the application 109 can be configured with a model artifact 115, an input path 118, an output path 121, an application priority 124, and other suitable data. In some instances, the management service 212 can identify a request to initiate scheduling because of a timer or a scheduling time period has been specified for the application 109.

The management service 212 can analyze the data attributes associated with the application 109 to identify applicable application templates 112 among various application templates 112. For example, the management service 212 can identify certain data attributes in the model artifact 115 and use the identified data attributes as a search criterion for application templates 112.

After a first set of application templates 112 have been generated, the management service 212 can determine the availability of the computing hardware infrastructure 106. In some instances, certain hardware platforms 138 may not be available because all of the processing slots may be occupied by other applications 109. As a result, certain hardware platforms 138 may be unavailable. As such, the unavailability of certain hardware platforms 138 may also remove the certain application templates 112 associated with the unavailable hardware platforms 138. Accordingly, the first set of application templates 112 can be reduced to a second set of application templates 112.

The management service 212 can select an application template 112 among the second set of application templates 112. In many examples, the management service 212 may select based at least in part a processing speed of the hardware platforms 138 or other characteristics associated with the hardware platforms 138.

Accordingly, the management service 212 can select the application template 112 to associate with the application 109 for execution, for example as an application package 103. The management service 212 can schedule the application package 103 to be executed on a hardware platform 138 based at least in part on the application priority 124. For instance, a first application 109 with a higher application priority 124 can be scheduled for execution before a second application 109 with a lower application priority 124.

In some examples, the management service 212 can identify the application priority 124 of the application 109 and make room for the application 109 on a certain hardware platform 138 because of the application priority 124. In this scenario, an existing executing application 109 may be terminated in order to free up an processing slot for an application 109 with a higher application priority 124.

With reference to FIG. 2, shown is a network environment 200 according to various embodiments. The network environment 200 can include a computing hardware infrastructure 106, a computing environment 203, and a client device 206, which can be in data communication with each other via a network 209.

The network 209 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 209 can also include a combination of two or more networks 209. Examples of networks 209 can include the Internet, intranets, extranets, virtual private networks (VPNs), and similar networks.

The computing environment 203 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 203 can employ a plurality of computing devices that can be arranged in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource or any other distributed computing arrangement. In some cases, the computing environment 203 can correspond to an elastic computing resource where the allotted capacity of processing, network, storage, or other computing-related resources can vary over time.

Various applications or other functionality can be executed in the computing environment 203. The components executed on the computing environment 203 include a management service 212, and other applications, services, processes, systems, engines, or functionality not discussed in detail herein.

The management service 212 can be executed to manage the scheduling and execution of machine learning model-based applications 109. In some instances, the management service 212 can orchestrate the entire execution lifecycle of a machine learning mode-based application 109. In some examples, the management service 212 can include a preparer service 215, a scheduler service 218, an executor service 221, a monitor service 224, and/or other suitable components.

The preparer service 215 can be executed to select an application template 112 in order to accelerate an execution of an application 109. The scheduler service 218 can be executed to schedule the execution of the application 109 on the computing infrastructure 106 based at least in part on run time data associated with the computing infrastructure 106. The executor service 221 can be used to execute the application 109 according to an application schedule. The application schedule can one or more instructions to be implemented for the execution of the application(s) 109.

The monitor service 224 can be executed to monitor the execution of the application 109 in order to record run time data, such as key metrics (e.g., execution time). The monitor service 224 can retrieve, measure, and/or store performance statistics associated present execution environments and historical execution environments. The present and historical run time data can be used by the scheduling service 218 to schedule subsequent applications 109.

Also, various data is stored in a data store 227 that is accessible to the computing environment 203. The data store 227 can be representative of a plurality of data stores 227, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 227 is associated with the operation of the various applications or functional entities described below. This data can include application code data 230, run time environment data 233 (hereinafter referred as “run time data 333”), and potentially other data.

The application code data 230 can represent data associated with one or application 109. The application code data 230 can include source code for the application 109, data attributes associated the application 109, and other suitable data. The application 109 can include the model artifacts 115, an input path 118, an output path 121, the application priority 124, and/or other suitable data elements. The application code data 230 can include data attributes associated with each of the elements of the application 109. For example, the application code data 230 can include data attributes associated with the availability and accessing the input path 118 and output path 121 at one more computing entities.

The run time data 233 can represent data associated with one or more execution environments 100 and the performance of applications 109 on the computing hardware infrastructure 106. The run time data 233 can include statistics data 236, the priority data 239, the template data 242, and other suitable data. The statistics data 236 (e.g., execution time) can represent data on performance metrics associated with run time execution of one or more applications 109. Some non-limiting examples of performance metrics can include execution time, processor utilization, memory utilization, classification metrics, regression metrics, and other suitable statistics data. The performance metrics can include metrics with existing applications 109 and historical data from previous executions of applications 109. In some instances, the present and/or historical statistics data 236 can be used for scheduling subsequent application packages 103.

The priority data 239 can represent data associated with application priority 124 for presently executed applications 109 and previously executed applications 109 (e.g., historical priority data). In some examples, the application priority 124 is extracted from the application 109 during the scheduling and/or the execution of the application 109.

The template data 242 can represent data associated with one or more application templates 112 stored in the data store 227. The application template 112 can represent a software stack or a set of software layer components that can be selected and used to execute the application 109 on a particular computing hardware infrastructure 106. In some examples, each application template 112 can be associated with a different arrangement of programming languages 127, modeling framework 130, execution framework 133, a computing hardware interface 136 for a hardware platform 138, and other suitable components. The application templates 112 can represent a set of components that are configured to accelerate an execution of application 109 for one or more hardware platforms 138.

The client device 206 is representative of a plurality of client devices that can be coupled to the network 209. The client device 206 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 206 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 206 or can be connected to the client device 206 through a wired or wireless connection.

The client device 206 can be configured to execute various applications such as a client application 245 or other applications. The client application 245 can be executed to configure the management service 212, manage the operation of the management service 212, and other suitable functionality associated with the management service 212. The client application 245 can be executed in a client device 206 to access network content served up by the computing environment 203 or other servers, thereby rendering a user interface 248 on the display. To this end, the client application 245 can include a browser, a dedicated application, or other executable, and the user interface 248 can include a network page, an application screen, or other user mechanism for obtaining user input. The client device 206 can be configured to execute applications beyond the client application 245 such as email applications, social networking applications, word processors, spreadsheets, or other applications.

Next, a general description of the operation of the various components of the network environment 200 is provided. To begin, the management service 212 can be involved during the development of a machine learning-based application 109. A software developer can generate the application 109 using the programming language 127. The software developer can generate the machine learning model using a specific a programming language 127 and a modeling framework 130. Then, the management service 212 be used to onboard the machine learning-based application 109 by processing the machine learning-based application 109 through a registration process. Then, the management service 212 can be used for a continuous integration and continuous development (CI/CD) process. This process can generate a model artifact 115, which includes the generation of code dependencies. Then, the management service 212 can store the machine learning-based application 109 in the data store 227 for execution.

In some examples, the management service 212 can receive a specification of a scheduling time for the application 109. The scheduling time can represent a specified time or time period for the management service 212 to start scheduling the application 109. At this time period, the management service 212 can retrieve the application 109 from the data store 227 and initiate a scheduling and execution process. In some instances, the management service 212 can retrieve a batch of applications 109 with a scheduling time within a time period window.

During the scheduling, the management service 212 can initiate a scheduling or an execution of an application 109. The management service 212 can determine an applicable application template 112. In some examples, the applicable application templates 112 can be determined based at least in part on data attributes associated with the model artifacts 115. In some instances, the management service 212 can also use the run time data 233 associated with the computing hardware infrastructure 106 to determine the availability of hardware platforms 138. The management service 212 can consider the availability of the hardware platforms 138 in the selection of an application template 112.

The selected application template 112 can be paired with the application 109 to form an application package 103. The management service 212 can schedule the application package 103 on a hardware platform 138 based at least in part on the application priority 124 for the application 109. For example, the management service 212 can schedule a first application 109 ahead of a second application 109 for execution on a particular hardware platform 138 because the first application 109 has a higher application priority 124 than the second application 109.

In some examples, the management service 212 can cancel a second application 109 that is presently being executed on a particular hardware platform 138 because the first application 109 has a higher application priority than the second application 109. As such, the management service 212 can provide a central priority-based scheduling service.

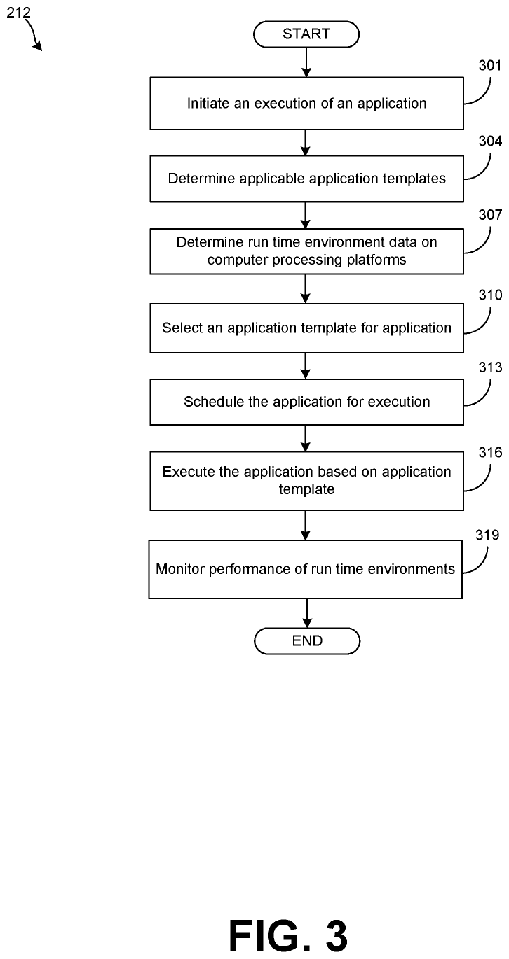

Referring next to FIG. 3, shown is a flowchart that provides one example of the operation of a portion of the management service 212. The flowchart of FIG. 3 provides merely an example of the many different types of functional arrangements that can be employed to implement the operation of the depicted portion of the management service 212. As an alternative, the flowchart of FIG. 3 can be viewed as depicting an example of elements of a method implemented within the network environment 200.

Beginning with block 301, the management service 212 can initiate an execution scheduling for the application 109. In some embodiments, the management service 212 can receive a request or a timer to initiate scheduling because of a scheduled time for initiating execution of the application 109. In some examples, the application 109 can have a schedule time for initiating execution and the management service 212 can retrieve a set of applications 109 with a schedule time within a time window.

In block 304, the management service 212 can identify a set of eligible application templates 112 for the application 109 based at least in part on the model artifact 115 for the application 109. In some examples, the management service 212 can identify data attributes associated with the model artifacts 115 and can use the identified data attributes as a searching criteria among the various application templates 112. The data attributes can include machine learning model parameters. In some instances, the data attributes can indicate a machine learning algorithm type, such as an artificial neutral network algorithm, a deep learning algorithm, a linear regression algorithm, a decision tree algorithm, and other suitable types. As a result, the data attributes associated with the model artifacts 115 can be used to determine applicable or eligible application templates 112.

In some examples, the management service 212 can identify the set of applicable application templates 112 based at least in part on one or more of the model artifact 115, the application priority 124, the run time data 233, and/or other suitable data elements. In some instances, the management service 212 calls or invokes the preparer service 215 to determine the set of applicable application templates 112.

In block 307, the management service 212 can determine run time data 233 associated with the computing hardware infrastructure 106. The run time data 233 can include statistics data 236 and availability data for various hardware platforms 138. The statistics data 236 can include execution time metrics and other performance metrics. The availability data can include if a particular hardware platform 138 has an available processing slot for an application 109, when processing slots will become available, and other suitable availability data.

In some instances, the availability data can be used to remove one or more application templates 112 from the set of applicable application templates 112. The one or more application templates 112 can be removed because they are associated with a hardware platform 138 that is unavailable for executing another application 109. The hardware platform 138 may be unavailable because all of its processing slots are occupied and/or the processing slots are occupied by applications 109 with higher application priorities 124.

In block 310, the management service 212 can select an application template 112 for the application 109 based at least in part on the set of applicable application templates 112 and the run time data 233. In some instances, the management service 212 can rank the set of applicable application templates 112 based at least on one or more attributes of the application templates 112 or an associated hardware platform 138 for the application templates 112. The attributes used for ranking and the selection can include, for example, an execution time, a quantity of available processing slots, memory, and other suitable attributes. The selection can also be based at least in part historical statistics data 236, priority data 239, and other suitable run time data 233. For examples, the management service 212 can select the application template 112 ranked to have the fast execution time among the set of applicable application templates 112.

In block 313, the management service 212 can schedule the application 109 for execution on a particular hardware platform 138 based at least in part on the selected application template 112 and the run time data 233. In some examples, the management service 212 can schedule the application 109 based at least in part on the application priority 124 for the application 109 and the priority data 239 for the existing executing applications 109 on a particular hardware platform 138.

In some examples, the management service 212 can identify an existing executing application 109 with an application priority 124 that is lower than the application priority 124 of the application 109 presently being scheduled. If all of the processing slots for the particular hardware platform 138 are occupied in this scenario, then the management service 212 can terminate the existing executing application 109 to make room for scheduling the present application 109 with the higher application priority 124. After the present application 109 has been scheduled for execution, the management service 212 can schedule the terminated application 109, in which case may include selecting a different application template 112 (block 210) because of the unavailability of the hardware platform 138.

In some examples, the management service 212 can generate an application schedule for the application 109, and the application schedule can include instructions for executing the application 109. For example, the application schedule can include instructions for terminating a lower priority application 109 and executing the present application 109 instead in a processing slot of a hardware platform 138. In another example, the application schedule can include instructions that represent an order or a sequence of executing multiple applications 109. In some instances, the management service 212 can call or invoke the scheduler service 218 to schedule the application 109 to executed with selected application template 112 and an applicable hardware platform 138.

In block 316, the management service 212 can execute the application 109 in the execution environment 100 (e.g., a run-time environment) specified by the application template 112, in which can involve executing the application 109 on the particular hardware platform 138. As such, the application template 112 can specify a configuration of the run-time environment for the execution of the application 109. In some examples, the management service 212 can execute the application 109 as determined by the scheduling process. For example, the management service 212 can execute a set of instructions or an application schedule for executing the application 109. For instance, the application schedule can indicate to execute the application 109 in the next available processing slot for the hardware platform 138 or to terminate an existing executing application 109 in order to create a free processing slot for the application 109. In some instances, the management service 212 can call or invoke the executor service 221 to execute the application 109 with selected application template 112 and the selected hardware platform 138.

In block 319, the management service 212 can monitor the performance of the application 109 during the execution. The management service 212 can collect and store various metrics for the execution of the application 109 as statistics data 236. In some examples, the management service 212 can call or invoke the monitor service 224 to monitor or observe the execution of the application 109 with selected application template 112 and the selected hardware platform 138 in the execution environment.

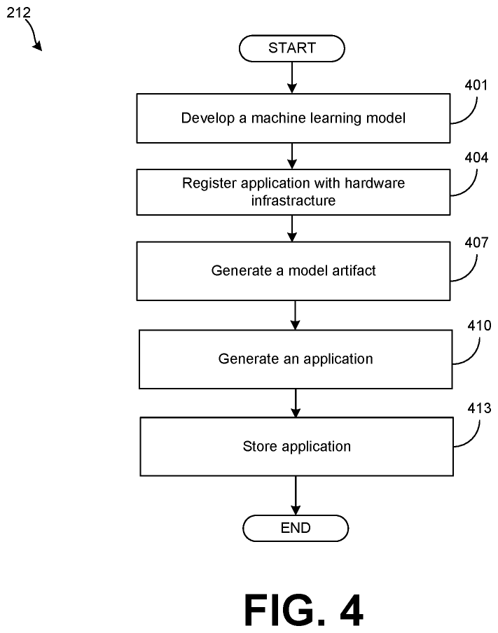

Referring next to FIG. 4, shown is a flowchart that provides one example of the operation of a portion of the management service 212. The flowchart of FIG. 4 provides merely an example of the many different types of functional arrangements that can be employed to implement the operation of the depicted portion of the management service 212. As an alternative, the flowchart of FIG. 4 can be viewed as depicting an example of elements of a method implemented within the network environment 200.

Beginning with block 401, the management service 212 can facilitate the development of a machine learning model by a developer. The machine learning model can be generated using one or more programming languages 127 and a modeling framework 130.

In block 404, the management service 212 can facilitate a registration of an application 109 associated with the machine learning model. As part of the registration process, the application 109 can be associated with applicable hardware platforms 138. For example, the registration of the application 109 can receive a specification of various hardware platforms 138 that can execute the application 109 (e.g., the machine learning model).

In block 407, the management service 212 can generate a model artifact 115 for the application 109. In some examples, the model artifact 115 can be generated from one or more machine learning training instances. The model artifacts 115 can be machine learning model parameters generated by the training instances. For example, a machine learning algorithm can be provided as input training data. From the training data, the machine learning algorithm can generate the model artifact 115, machine learning parameters, and other suitable data elements.

In block 410, the management service 212 can generate the application 109 as part of an onboarding process. The management service 212 can receive a specification of one or more application attributes, such an input path 118, an output path 121, an application priority 124, and/or other suitable application attributes. The input path 118 can include a memory location in the data store 227 of the computing environment 203 or an external computing environment. The input path 118 can also include availability parameters (e.g., timing conditions, scenario conditions, etc.) for accessing the input data. The output path 121 can include availability parameters for storing the output data at the specified memory location.

In block 413, the management service 212 can store the application 109 in the application code data 230. In some instances, the application 109 is stored with a timer or a time period for initiating an execution of the application 109.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts FIGS. 3 and 4 show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts FIGS. 3 and 4 show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts FIGS. 3 and 4 can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 203.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
initiate a run-time execution of an application that includes a machine learning model;
determine a plurality of eligible application templates based at least in part on a machine learning model artifact for the application;
select an application template among the plurality of eligible applications templates based at least in part on an application priority for the application and run time environment data associated with an execution of a plurality of existing applications, the application template comprising a computing hardware interface and a software framework; and
execute the application in a run-time environment specified by the application template.

2. The system of claim 1, wherein the machine-readable instructions further cause the computing device to at least:
determine an availability of a plurality of hardware platforms based at least in part on the run time environment data for the plurality of hardware platforms.

3. The system of claim 2, wherein the machine-readable instructions further cause the computing device to at least:
generate an application schedule for an execution of the application based at least in part on the availability of at least one hardware platform and the application priority for the application, wherein the execution of the application is further performed in the run-time environment based at least in part on the application schedule.

4. The system of claim 1, wherein the machine-readable instructions further cause the computing device to at least:
generate an application schedule for an execution the application based at least in part on the application priority for the application.

5. The system of claim 4, wherein the application schedule comprises an instruction to terminate the execution of a respective application on a respective hardware platform based at least in part on the application priority being higher than a respective priority of the respective application.

6. The system of claim 1, wherein the computing hardware interface is used by the software framework to execute at least one a portion of the application on one of the plurality of hardware platforms.

7. The system of claim 1, wherein the software framework comprises a modeling framework and a distributed computing execution framework.

8. A method, comprising:
initiating, by at least one computing device, a run-time execution of an application that includes a machine learning model;
determining, by the at least one computing device, a plurality of applicable application templates based at least in part on a machine learning model artifact for the application;
selecting, by the at least one computing device, an application template among a plurality of eligible application templates based at least in part on an application priority for the application and run time environment data associated with an execution of a plurality of existing applications, the application template comprising a computing hardware interface and a software framework; and
executing, by the at least one computing device, the application in a run-time environment specified by the application template.

9. The method of claim 8, further comprising:
determining, by the at least one computing device, an availability of a plurality of hardware platforms based at least in part on the run time environment data for the plurality of hardware platform.

10. The method of claim 9, further comprising:
generating, by the at least one computing device, an application schedule for an execution the application based at least in part on the availability of at least one hardware platform and the application priority for the application, wherein the execution of the application is further performed in the run-time environment based at least in part on the application schedule.

11. The method of claim 8, further comprising:
generating, by the at least one computing device, an application schedule for an execution of the application based at least in part on the application priority for the application.

12. The method of claim 11, wherein the application schedule comprises an instruction to terminate the execution of a respective application on a respective hardware platform based at least in part on the application priority being higher than a respective priority of the respective application.

13. The method of claim 8, wherein the computing hardware interface is used by the software framework to execute at least one a portion of the application on one of a plurality of hardware platforms.

14. The method of claim 8, wherein the software framework comprises a modeling framework and an execution framework.

15. A non-transitory, computer-readable medium, comprising machine-readable instructions that, when executed by a processor of a computing device, cause the computing device to at least:
initiate a run-time execution of an application that includes a machine learning model;
determine a plurality of eligible application templates based at least in part on a machine learning model artifact for the application;
select an application template among the plurality of eligible applications templates based at least in part on an application priority for the application and run time environment data associated with an execution of a plurality of existing applications, the application template comprising a computing hardware interface and a software framework; and
execute the application in a run-time environment specified by the application template.

16. The non-transitory, computer-readable medium of claim 15, wherein the machine-readable instructions further cause the computing device to at least:
determine an availability of a plurality of hardware platforms based at least in part on the run time environment data for the plurality of hardware platform.

17. The non-transitory, computer-readable medium of claim 16, wherein the machine-readable instructions further cause the computing device to at least:
generate an application schedule for an execution of the application based at least in part on the availability of at least one hardware platform and the application priority for the application, wherein the execution of the application is further performed in the run-time environment based at least in part on the application schedule.

18. The non-transitory, computer-readable medium of claim 15, wherein the machine-readable instructions further cause the computing device to at least:
generate an application schedule for an execution the application based at least in part on the application priority for the application.

19. The non-transitory, computer-readable medium of claim 18, wherein the application schedule comprises an instruction to terminate the execution of a respective application on a respective hardware platform based at least in part on the application priority being higher than a respective priority of the respective application.

20. The non-transitory, computer-readable medium of claim 15, wherein the software framework comprises a modeling framework and a distributed computing execution framework.
